(19) United States
(12) Patent Application Publication
(10) Pub. No.: US 2025/0298227 A1
(43) Pub. Date: Sep. 25, 2025

(54) DISPLAY OPTICAL SYSTEM AND IMAGE DISPLAY APPARATUS

(71) Applicant: CANON KABUSHIKI KAISHA, Tokyo (JP)

(72) Inventors: MASAKAZU TOHARA, Tokyo (JP); RYOJI KONDO, Kanagawa (JP)

(21) Appl. No.: 19/069,890

(22) Filed: Mar. 4, 2025

(30) Foreign Application Priority Data
Mar. 19, 2024 (JP) 2024-043099

(51) Int. Cl. G02B 17/08

(52) U.S. Cl. CPC G02B 17/0856

(57) ABSTRACT

Provided is a display optical system that guides light from a display element to an observation side, and includes a partially transmissive reflective surface having reflectance of 35% or less for visible light and including a dielectric multilayer film including between five and ten layers, and a polarizing splitting surface.

### BACKGROUND

### Technical Field

The present disclosure relates to a display optical system suitable for an image display apparatus such as a head mount display (HMD) configured to display an enlarged original image displayed on a display element.

### Description of Related Art

Japanese Domestic PCT Application Publication No. 2020-515903 and Japanese Patent Application Laid-Open No. 2021-124539 discuss an optical system configured to fold an optical path utilizing polarization and including a polarization selective element (polarizing beam splitter) and a half-mirror.

Japanese Domestic PCT Application Publication No. 2020-515903 and Japanese Patent Application Laid-Open No. 2021-124539 discuss reflectance of the half-mirror.

### SUMMARY

An aspect of the disclosure provides a display optical system configured to guide light from a display element to an observation side The display optical system includes a partially transmissive reflective surface including a dielectric multilayer film including five layers or more and ten layers or less, and a polarizing splitting surface, with the partially transmissive reflective surface having a reflectance of 35% or less for visible light.

Further features of various embodiments of the disclosure will become apparent from the following description of embodiments with reference to the attached drawings.

### BRIEF DESCRIPTION OF THE DRAWINGS

FIG. 1 is a plan view illustrating the configuration of an image display apparatus according to a first example of the present disclosure.

FIG. 2 is a sectional view of the display optical system of FIG. 1.

FIG. 3 is an external perspective view of the image display apparatus according to the first example of the present disclosure.

FIG. 4 illustrates a relationship between the display optical system of the first example of the present disclosure and an eyeball.

FIG. 5 illustrates an optical path of an external light ghost in the display optical system according to the first example of the present disclosure.

FIG. 6 illustrates an optical path of an internal ghost in the display optical system according to the first example of the present disclosure.

FIG. 7 illustrates an optical path of an external light ghost in the display optical system according to the first example of the present disclosure.

FIG. 8 illustrates the reflectance characteristic of a half-mirror of the first example of the present disclosure.

FIG. 9 illustrates another reflectance characteristic of the half-mirror of the first example of the present disclosure.

FIG. 10 illustrates another reflectance characteristic of the half-mirror of the first example of the present disclosure.

FIG. 11 is a plan view illustrating the configuration of an image display apparatus according to a second example of the present disclosure.

FIG. 12 illustrates the configuration of a display optical system according to the second example of the present disclosure.

FIG. 13 illustrates the optical path of an internal ghost in the display optical system according to the second example of the present disclosure.

FIG. 14 illustrates the reflectance characteristic of a half-mirror of the second example of the present disclosure.

FIG. 15 illustrates another reflectance characteristic of the half-mirror of the second example of the present disclosure.

FIG. 16 illustrates another reflectance characteristic of the half-mirror of the second example of the present disclosure.

FIG. 17 illustrates a cemented lens in the display optical system according to the second example of the present disclosure.

FIG. 18 illustrates another reflectance characteristic of the half-mirror of the second example of the present disclosure.

FIG. 19 illustrates visual line (line-of-sight) detection in the display optical system according to the second example of the present disclosure.

FIG. 20 illustrates another reflectance characteristic of the half-mirror of the second example of the present disclosure.

### DETAILED DESCRIPTION

Referring now to the accompanying drawings, a detailed description will be given of examples according to the disclosure.

### EXAMPLE 1

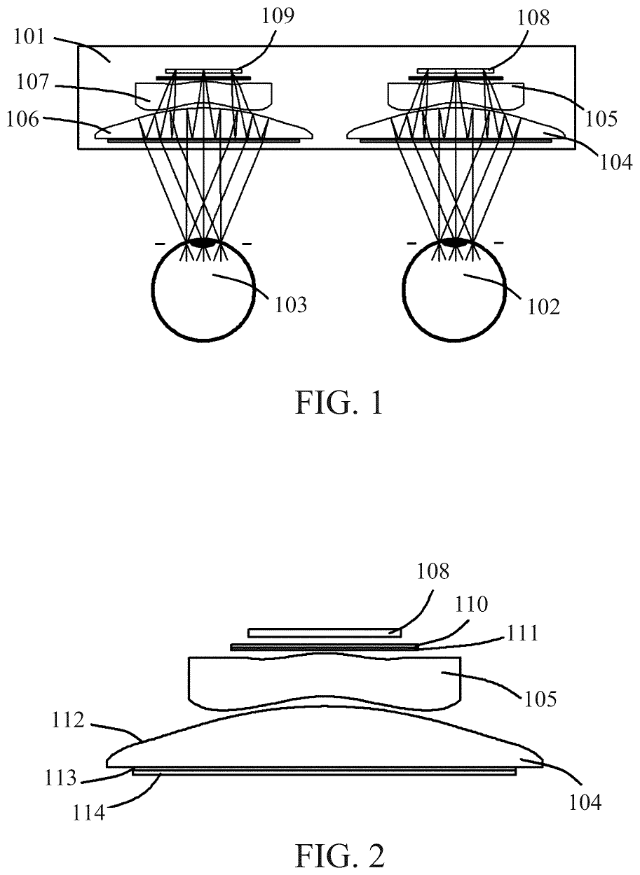

FIG. 1 illustrates the configuration of an HMD 101 as an image display apparatus using a display optical system according to Example 1, viewed from above. Reference numeral 102 denotes the right eye of an observer, and reference numeral 103 denotes the left eye of the observer. Lenses 104 and 105 constitute a part of a right-eye display optical system, and lenses 106 and 107 constitute a part of a left-eye display optical system. Reference numeral 108 denotes a right-eye display element, and reference numeral 109 denotes a left-eye display element. Each display element in this example uses an organic EL element, and emits three colors of light, i.e., red light, blue light, and green light.

The right-eye display optical system enlarges light from an original image displayed on the right-eye display element 108 to form a virtual image, and guides it to the right eye 102 disposed at the exit pupil on the observation side of the display optical system. The left-eye display optical system enlarges light from an original image displayed on the left-eye display element 109, and guides it to the left eye 103 disposed at the exit pupil on the observation side of the display optical system. The “virtual image,” as used herein, refers to an image that is created when light rays from an object point are diverged by a lens and the like and then these divergent light rays are imaged.

In each of the right-eye display optical system and the left-eye display optical system, a focal length f1 is 12 mm, a horizontal display angle of view is 45°, a vertical display angle of view is 34°, and a diagonal display angle of view is 54°. A distance (eye relief) E1 between the HMD 101 and the observer's eyeball is 18 mm.

The display optical system according to this example is an optical system configured to fold the optical path utilizing polarization, and its specific configuration will be described using the right-eye display optical system illustrated in FIG. 2. The right-eye display optical system includes, in order from the display element side, a first polarizing plate 110 and a first waveplate (phase plate) 111 disposed between the right-eye display element 108 and the lens 105. The first polarizing plate 110 and the first waveplate 111 are each formed in a flat shape and are stacked on each other.

A half-mirror 112 constituting a partially transmissive reflective surface is formed by vapor deposition on the surface on the display element side (lens 105 side) of the lens 104. Between the lens 104 and the right eye 102, a second waveplate (phase plate) 113 and a polarizing beam splitter (PBS) 114 constituting a polarizing splitting surface are arranged in this order from the display element side (lens 104 side). The polarizing splitting surface is an optically functional surface whose transmittance and reflectance change according to the polarization direction of the incident light. Each of the second waveplate 113 and the PBS 114 has a flat shape, and they are stacked on each other, and adhered to the flat surface on the exit pupil side (eyeball side) of the lens 104. Each of the first waveplate 111 and the second waveplate 113 has a phase difference of λ/4.

The polarization direction of the polarized light that transmits through the first polarizing plate 110 and the slow axis of the first waveplate 111 are tilted by 45°. The polarization direction of the polarized light that transmits through the first polarizing plate 110 and the slow axis of the second waveplate 113 are tilted by −45°. The polarization direction of the polarized light that transmits through the first polarizing plate 110 and the polarization direction of the polarized light that transmits through the PBS 114 are orthogonal to each other. The “slow axis,” as used herein, refers to an axis (or axial direction) that maximizes a refractive index in a polarization direction of incident light.

In the above configuration, the unpolarized light emitted from the right-eye display element 108 transmits through the first polarizing plate 110 and becomes linearly polarized light, and this linearly polarized light transmits through the first waveplate 111 and becomes circularly polarized light. The circularly polarized light that transmits through the half-mirror 112 transmits through the second waveplate 113 and becomes linearly polarized light, and since the polarization direction of this linearly polarized light is orthogonal to the polarization direction of the light that transmits through the PBS 114, it is reflected by the PBS 114. The reflected linearly polarized light then transmits through the second waveplate 113 and becomes circularly polarized light.

The circularly polarized light reflected by the half-mirror 112 transmits through the second waveplate 113 and becomes linearly polarized light. Since the polarization direction of this linearly polarized light accords with the polarization direction of the light that transmits through the PBS 114, it transmits through the PBS 114 and is guided to the right eye 102. The above configuration is similarly applied to the left-eye display optical system.

Folding the optical path utilizing polarization as in this example can provide the display optical system with a reduced thickness and focal length, and can achieve image observation with a wide angle of view.

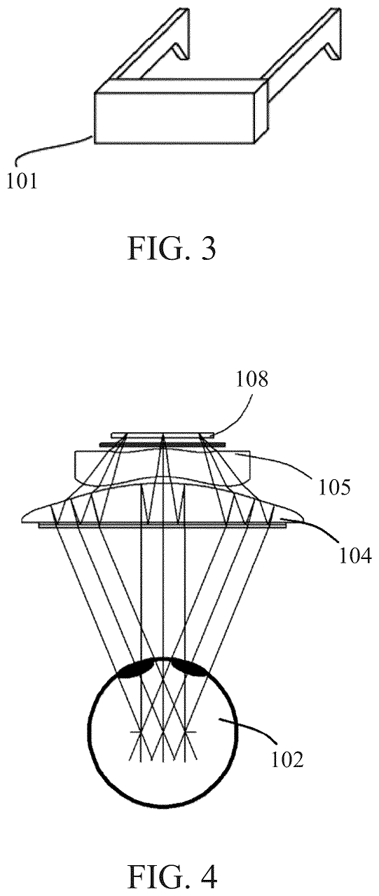

FIG. 3 illustrates the appearance of the HMD 101. Since the HMD 101 is worn on the observer's head, it may be lightweight. Thus, the lenses that constitute the display optical system may be made of resin, which has a smaller specific gravity than that of glass, and in this example, the lenses 104 and 106 are made of resin. In addition, in a case where the lenses 104 and 106 are aspherical lenses with plano-convex shapes, the aberration correction effect can be improved. The lenses 105 and 107 are double-sided aspherical lenses made of resin.

The exit pupil of the display optical system in this example is located at a position of 28 mm, which is the sum of the eye relief of 18 mm and the rotation radius of the eyeball (102) of 10 mm, as illustrated in FIG. 4, and the exit pupil diameter is 6 mm. By so doing, even in a case where the eyeball rotates to observe up, down, left, or right, the light in that direction enters the eyeball. The eye relief may be 15 mm or more so that an observer wearing glasses can wear the HMD 101. As the eye relief increases, the outer shapes of the lens and the HMD 101 increase, so the eye relief may be 25 mm or less.

In the display optical system according to this example, the surface on which the half-mirror 112 is vapor-deposited (the surface on the display element side of the lens 104) is a surface that is convex toward the display element side. Vapor-depositing the half-mirror 112 on this convex surface can achieve a wide angle of view and reduce the thickness of the display optical system. In a case where the convex surface on which the half-mirror 112 is vapor-deposited has an aspheric shape, the aberration correction effect can be improved.

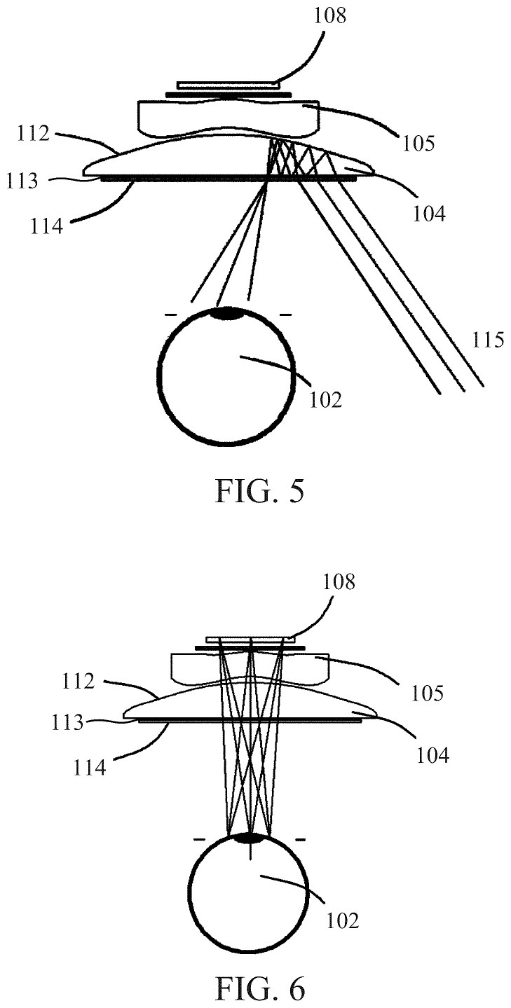

Since the half-mirror 112 is disposed inside the display optical system according to this example, as illustrated in FIG. 5, external light 115 as unnecessary light incident on the display optical system from the outside of the eyeball (102) is reflected multiple times by the half-mirror 112 and the PBS 114, is guided to the eyeball, and becomes an external light ghost. This external light ghost is displayed on the display image, and thus the observer cannot properly observe the image because of the distracting external light ghost.

Accordingly, in this example, the reflectance of the half-mirror 112 is 35% to reduce the amount of external light ghost. Since the reflectance of the conventional half-mirror is 50%, the efficiency (amount of external light entering the eyeball) in a case where the external light is reflected twice is 25%. On the other hand, in a case where the reflectance of the half-mirror 112 is set to 35%, the efficiency in two reflections is 12%, which is about half of the conventional efficiency. Thus, in order to reduce the external light ghost, the reflectance of the half-mirror 112 may be 35% or less.

The reflectance of the half-mirror in this example (and in Example 2 described later) is a value in the wavelength range of visible light (such as wavelengths of 400 nm to 700 nm). However, in a case where the reflectance differs for each wavelength, the average reflectance in the visible light range may be used. It may be the reflectance for a representative wavelength with high relative luminosity, such as the green light among the red, blue, and green light. In a case where the reflectance characteristic of the half-mirror differs according to an incident angle, it may be the reflectance at a specific incident angle (such as an incident angle of 0°) or the reflectance at the incident angle of ghost light, which will be described later.

On the other hand, the reflectance of the half-mirror 112 may be 20% or more. This is because in a case where the reflectance is less than 20%, the display efficiency for the light emitted from the display element 108 drops too much, and a bright display image cannot be observed. In a case where the conventional half-mirror with a reflectance of 50% is used, the display efficiency is 25%, which is calculated by multiplying the reflectance by the transmittance. In contrast, in a case where the reflectance of the half-mirror 112 is 20%, the reflectance times transmittance is 16%, which is about 60% lower than the conventional one.

Table 1 summarizes the film configuration of the half-mirror 112 in this example, and FIG. 8 illustrates the reflectance characteristic (spectral characteristic) of the half-mirror 112. A horizontal axis represents wavelength, and a vertical axis represents reflectance. As illustrated in Table 1, the half-mirror 112 made from a dielectric multilayer film can achieve a half-mirror with a lower reflectance than that of the conventional one. Table 1 illustrates the refractive index and film thickness of each layer (film) of the substrate and the dielectric multilayer film formed on the substrate (this also applies to other tables described later). The dielectric multilayer film that constitutes the half-mirror 112 includes layers of silicon oxide (SiO₂) and layers of niobium oxide (Nb₂O₅) alternately. In a case where a metal film such as silver is used to vapor-deposit a half-mirror with low reflectance, the metal film becomes too thin, and the vapor deposition becomes difficult. Thus, a half-mirror with low reflectance may be made from a dielectric multilayer film.

TABLE 1

| | REFRACTIVE INDEX | FILM THICKNESS [nm] |
|---|---|---|
| SUBSTRATE | 1.54 | |
| SiO₂ | 1.46 | 187.8 |
| Nb₂O₅ | 2.15 | 54.9 |
| SiO₂ | 1.46 | 87.7 |
| Nb₂O₅ | 2.15 | 85.0 |
| SiO₂ | 1.46 | 174.2 |

In using a half-mirror 112 with a low reflectance as in this example, the variation (fluctuation or change) of the reflectance in the mirror surface significantly affects the display efficiency of the light from the display element 108. Thus, the variation of the reflectance (and transmittance) in the mirror surface of the half-mirror 112 may be ±5% or less. In a case where the conventional half-mirror with the reflectance of 50% is used, the display efficiency is 25% (reflectance×transmittance) as described above, but in a case where the reflectance and transmittance vary by ±10%, the display efficiency becomes 24%, which is a decrease of 1%. On the other hand, in a case where the half-mirror 112 with the reflectance of 35% is used, the display efficiency (reflectance×transmittance) is 22.75%, but in a case where the reflectance and transmittance vary by ±10%, the display efficiency becomes 18.75%, which is a decrease of 4%. Thus, this example keeps the variation in reflectance and transmittance to ±5% by reducing the variation in the thickness of the dielectric multilayer film. As a result, the display efficiency (reflectance×transmittance) is 21%, which is a suppressed decrease of 1.75%.

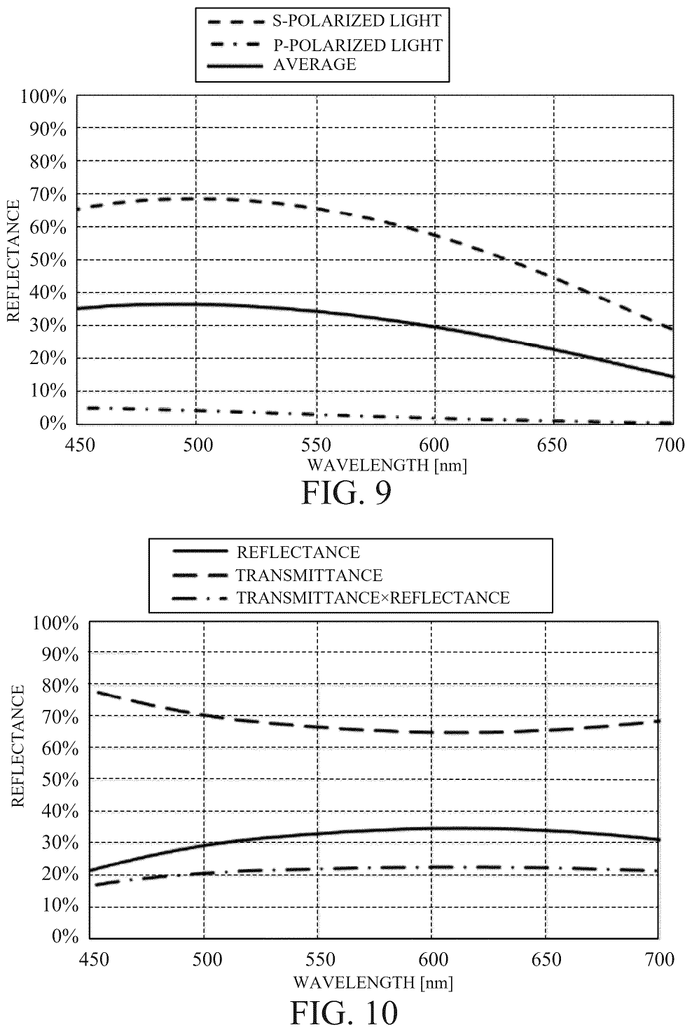

In the half-mirror 112 including the dielectric multilayer, the polarization characteristic changes according to an incident angle of the light on the half-mirror 112. FIG. 9 illustrates the reflectance characteristic of the half-mirror 112 in a case where the incident angle of the light on the half-mirror 112 is 45°. A horizontal axis represents wavelength, and a vertical axis represents reflectance. As the incident angle increases, a reflectance difference between S-polarized light and P-polarized light (first linearly polarized light and second linearly polarized light) incident on the half-mirror 112 increases. In this case, unpolarized external light incident on the display optical system becomes linearly polarized light when it transmits through the PBS 114, and this linearly polarized light becomes circularly polarized light when the linearly polarized light transmits through the second waveplate 113. In a case where the circularly polarized external light is reflected by the half-mirror 112 that has no polarization characteristic, it is reflected as circularly polarized light, but if the half-mirror 112 has a polarization characteristic, it is reflected as elliptically polarized light. In a case where the reflected external light becomes elliptically polarized light and transmits through the second waveplate 113 and enters the PBS 114, it is separated into light that transmits through the PBS 114 and exits the display optical system, and light that is reflected by the PBS 114.

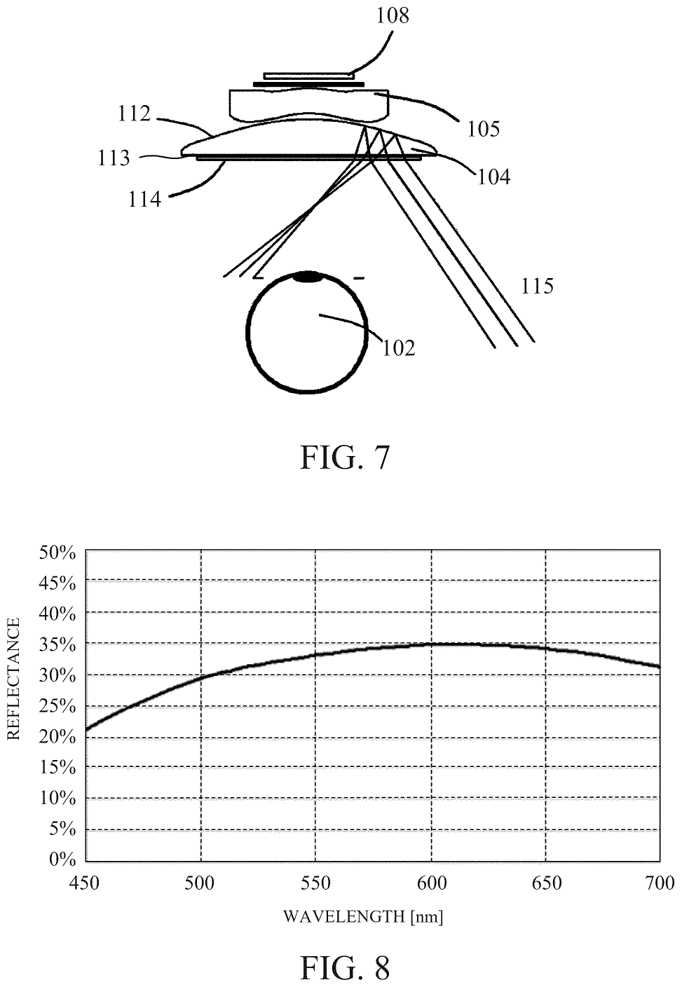

As illustrated in FIG. 7, the light that is reflected once by the half-mirror 112 and exits the display optical system follows an optical path that is less likely to be guided to the eyeball, and is less likely to become an external light ghost. In addition, an amount of light that is reflected twice by the half-mirror 112 and exits the display optical system is reduced because light occurs that is reflected once by the half-mirror 112 and exits the display optical system, and thus the external light ghost is reduced.

The reflectance difference on the half-mirror 112 between S-polarized light and P-polarized light as visible light may be 20% or more. This configuration improves the effect of reducing the external light ghost caused by the external light that is reflected twice by the half-mirror 112.

In a display optical system utilizing polarization as in this example, ghost light, which is unnecessary light that does not follow the optical path of the normal light (effective visible light that contributes to image display) illustrated in FIG. 1, is generated due to the birefringence of the lenses 104 to 107 and the polarization characteristics of the polarizing plate 110, the first and second waveplates 111 and 113, and the PBS 114. That is, as illustrated in FIG. 6, an internal ghost is generated by ghost light that is guided to the eyeball without being reflected by the PBS 114. More specifically, the unpolarized light emitted from the display element 108 transmits through the first waveplate 111 and becomes circularly polarized light, but the circularly polarized light becomes elliptically polarized light due to the birefringence of the lenses 105 and 104. In a case where the elliptically polarized light enters the second waveplate 113, the polarization direction of the linearly polarized light that transmits through it is tilted relative to the polarization direction of the polarized light reflected by the PBS 114. As a result, ghost light is generated that transmits through the PBS 114, and this is guided to the eyeball (102) to generate an internal ghost. Even if the lens has no birefringence, if the polarization characteristics of the polarizing plate 110, the first and second waveplates 111 and 113, and the PBS 114 are not good, an internal ghost occurs.

In a case where the optical path of the normal light in FIG. 1 is compared with the optical path of the ghost light in FIG. 6, in the optical path of the normal light, the light emitted from the display element 108 transmits through and is reflected by the half-mirror 112, but in the optical path of the ghost light, the light only transmits through the half-mirror 112. Thus, in a case where the reflectance of the half-mirror 112 is low and the transmittance is high as in this example, the intensity of the internal ghost increases.

Hence, the birefringence in an area near the center of each of the lenses 104 to 107 may be small. In this example, a phase difference amount per mm of the lens thickness of the lenses 104 and 106 is 2 nm/mm, and a phase difference amount per mm of the lens thickness of the lenses 105 and 107 is 5 nm/mm. The phase difference amount per mm of the lens thickness of each lens may be 10 nm/mm or less. In addition, since light transmits through the lenses 104 and 106 three times, the birefringence may be smaller, for example, the phase difference amount per mm of the lens thickness may be 5 nm/mm or less.

Any reflectance difference of the half-mirror 112 for each wavelength causes a difference between the spectral characteristic of the half-mirror 112 in the optical path of the normal light and the spectral characteristic of the half-mirror 112 in the optical path of the ghost light. As described above, in a case where the optical path of normal light in FIG. 1 is compared with the optical path of ghost light in FIG. 6, in the optical path of normal light, the light emitted from the display element 108 transmits through and reflected by the half-mirror 112, but in the optical path of ghost light, the light only transmits through the half-mirror 112. Thus, any reflectance difference of the half-mirror 112 for each wavelength causes a difference between the spectral characteristic of the half-mirror 112 for the normal light and the spectral characteristic of the half-mirror 112 for the ghost light, and the color shift between the normal light and the ghost light increases, the ghost light is likely to stand out, i.e., likely to be emphasized/stressed.

Accordingly, this example sets the reflectance and transmittance characteristics of the half-mirror 112 at an incident angle of 0° as illustrated in FIG. 10. In FIG. 10, a horizontal axis represents wavelength, and a vertical axis represents reflectance. In other words, this example reduces the difference between the spectral characteristic of the half-mirror 112 for the normal light and the spectral characteristic of the half-mirror 112 for the ghost light by reducing the reflectance difference of the half-mirror 112 for each wavelength within the visible light range. In FIG. 10, the spectral characteristic of the half-mirror 112 for the normal light is illustrated in a graph of “transmittance×reflectance,” and the spectral characteristic of the half-mirror 112 for the ghost light is illustrated in a graph of “transmittance.” Since the difference in the spectral characteristic illustrated in these graphs is small, the color shift between the normal light and the ghost light is small, and the ghost light is less likely to stand out.

For example, the dominant wavelength of the blue light emitted from the display element 108 is 450 nm, the dominant wavelength of the green light is 525 nm, and the dominant wavelength of the red light is 610 nm. The reflectance of the half-mirror 112 for the first wavelength of 450 nm, the second wavelength of 525 nm, and the third wavelength of 610 nm is 22%, 32%, and 35%, respectively. In this case, a difference between the maximum and minimum reflectance values at the dominant wavelengths of the blue, green, and red light emitted from the display element 108 is 13%. This difference may be 15% or less. In a case where the difference is 15% or less, the color shift between the normal light and the ghost light due to the difference in the spectral characteristic of the half-mirror 112 is small, and the ghost light is less likely to stand out. In order to further reduce the color shift between the normal light and the ghost light, this difference may be 5% or less.

The first to third wavelengths that define the reflectance difference of the half-mirror 112 for the normal light and the ghost light may be set to match the dominant wavelengths of the blue, green, and red light emitted from the display element 108. This configuration can reduce the color shift between the normal light and the ghost light in accordance with the spectral characteristic of the light emitted from the display element 108. However, in a case where the reflectance difference for each wavelength of the half-mirror 112 is small as in this example, the first to third wavelengths do not necessarily need to accord with the dominant wavelengths of the blue, green, and red light from the display element 108.

Generally, the dominant wavelength of the blue light emitted from the display element is often included in the range of 430 to 480 nm, and the dominant wavelength of the green light is often included in the range of 520 to 570 nm. The dominant wavelength of the red light is often included in the range of 600 to 650 nm. Thus, the first wavelength may be included in the range of 430 to 480 nm, the second wavelength may be included in the range of 520 to 570 nm, and the third wavelength may be included in the range of 600 to 650 nm. Thereby, color shifts between blue, green, and red can be reduced.

In this example, the dielectric multilayer film serving as the half-mirror 112 has a five-layer structure. The number of layers of the dielectric multilayer film may be 5 or more and 10 or less. In a case where the number of layers is less than five, the variation in reflectance for each wavelength increases, the color shift between the ghost light and the normal light increases, and the ghost light stands out. In a case where the number of layers is more than ten, the durability of the dielectric multilayer film decreases.

In this example, the lenses 105 and 107 are made of resin lenses as described above, but the lenses 105 and 107 may be made of glass lenses because they have a small outer diameter and have little influence on the weight increase of the display optical system. The birefringence of glass lenses is very small, and high-quality images can be observed.

In order to reduce an external light ghost and increase the contrast of the displayed image, a second polarizing plate may be disposed between the PBS 114 and the eyeball (102).

In this example, the surface on the eyeball side of the lens 104, on which the second waveplate 113 and the PBS 114 are provided, is flat so as to achieve both a long eye relief and a thin display optical system. In a case where this surface has a concave shape toward the eyeball side, the thickness of the lens 104 increases in order to secure the eye relief at the periphery of the surface. In a case where the surface has a convex shape toward the eyeball side, the thickness of the lens 104 increases in order to secure the thickness of the edge portion of the lens 104. Thus, in this example, the lens 104 is a plano-convex lens.

As described above, the phase difference of each of the first and second waveplates 111 and 113 in this example is λ/4, but the phase difference may be shifted from λ/4 to cancel the birefringence of the lenses 104 and 105. In this case, the sum of the phase differences of the lens 104 and the second waveplate 113 may be 3λ/20 or more and 7λ/20 or less. The sum of the phase differences of the lens 105 and the first waveplate 111 may be 3λ/20 or more and 7λ/20 or less. In a case where the sum of the phase differences is out of these ranges, the intensity of the ghost light increases and good image observation cannot be obtained.

In this example, an organic EL element configured to emit unpolarized light is used as the display element, but by using a liquid crystal element configured to emit linearly polarized light, the first polarizing plate 110 can be omitted and the thickness of the display optical system can be further reduced.

### EXAMPLE 2

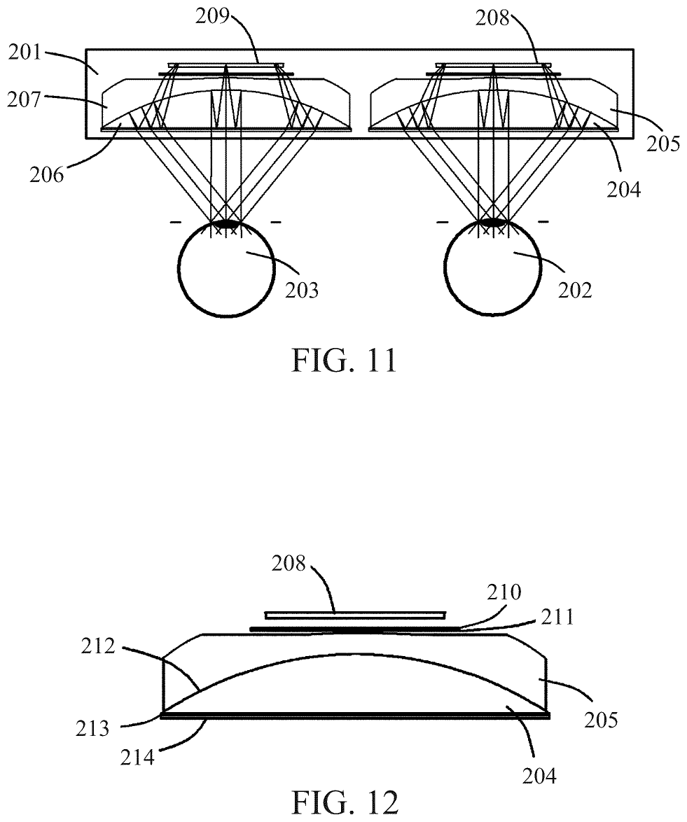

FIG. 11 illustrates the configuration of an HMD 201 as an image display apparatus using a display optical system according to Example 2, viewed from above. Reference numeral 202 denotes the right eye of an observer, and reference numeral 203 denotes the left eye of the observer. Lenses 204 and 205 are cemented together to form a part of a right-eye display optical system, and lenses 206 and 207 are cemented together to form a part of a left-eye display optical system. Reference numeral 208 denotes the right-eye display element, and reference numeral 209 denotes the left-eye display element. In this example, each display element uses an organic EL element.

The right-eye display optical system enlarges light from an original image that is displayed on the right-eye display element 208 to form a virtual image and guides it to the right eye 202 disposed on the observation side. The left-eye display optical system enlarges light from an original image displayed on the left-eye display element 209 and guides it to the left eye 203 disposed on the observation side.

In each of the right-eye display optical system and the left-eye display optical system, a focal length f2 is 13 mm, a horizontal display angle of view is 60°, a vertical display angle of view is 60°, and a diagonal display angle of view is 78°. An eye relief E2 is 20 mm.

The display optical system according to this example is also an optical system configured to fold the optical path utilizing polarization, and its specific configuration will be described with reference to the right-eye display optical system illustrated in FIG. 12. The right-eye display optical system includes a first polarizing plate 210 and a first waveplate 211 disposed between the right-eye display element 208 and the lens 205, and a half-mirror 212 that constitutes a partially transmissive reflective surface disposed at the cemented portion between the lenses 204 and 205 that are cemented together. The half-mirror 212 is vapor-deposited on the surface of the lens 204 that faces the lens 205. The right-eye display optical system further includes, in order from the display element side, a second waveplate 213 and a PBS 214 disposed between the lens 204 and the right eye 202. The second waveplate 213 and the PBS 214 are stacked on each other and adhered to the flat surface on the eyeball side of the lens 204. Both the first and second waveplates 211 and 213 are waveplates with a phase difference of λ/4.

The polarization direction of the polarized light that transmits through the first polarizing plate 210 and the slow axis of the first waveplate 211 are tilted by 45°. The polarization direction of the polarized light that transmits through the first polarizing plate 210 and the slow axis of the second waveplate 213 are tilted by −45°. The polarization direction of the polarized light that transmits through the first polarizing plate 210 and the polarization direction of the polarized light that transmits through the PBS 214 are orthogonal to each other.

In the above configuration, the unpolarized light emitted from the right-eye display element 208 transmits through the first polarizing plate 210 and becomes linearly polarized light. The linearly polarized light transmits through the first waveplate 211 and becomes circularly polarized light. This circularly polarized light transmits through the half-mirror 214, then transmits through the second waveplate 213, and becomes linearly polarized light. Since the polarization direction of this linearly polarized light is orthogonal to the polarization direction of the polarized light that has passed through the PBS 214, it is reflected by the PBS 214, transmits through the second waveplate 213, and becomes circularly polarized light. The circularly polarized light reflected by the half-mirror 214 transmits through the second waveplate 213 and becomes linearly polarized light. Since the polarization direction of this linearly polarized light accords with the polarization direction of the polarized light that has transmitted through the PBS 214, it transmits through the PBS 214 and is guided to the right eye 202.

Folding the optical path using polarized light as in this example can provide the display optical system with a reduced thickness and focal length, and achieves image observation with a wide angle of view.

In this example, in order to reduce weight, the lenses 204, 205, 206, and 207 are all made of resin lenses. Also, aspherical lenses are used to improve the aberration correction effect. The exit pupil position of the display optical system in this example is 30 mm, which is the sum of an eye relief of 20 mm and the rotation radius of the eyeball of 10 mm, and the exit pupil diameter is 6 mm.

In this example, the surface of the lens 204 on which the half-mirror 212 is vapor-deposited is a convex surface toward the display element side. Vapor-depositing the half-mirror 212 on this convex surface can reduce the thickness of the display optical system and achieve a wide angle of view. The aspheric convex surface on which the half-mirror 212 is vapor-deposited can improve the aberration correction effect.

On the other hand, since the half-mirror 212 is disposed inside the display optical system in this example, as in Example 1, external light entering the display optical system is multiple-reflected by the half-mirror 212 and the PBS 214 and is guided to the eyeball (202), an external light ghost is generated, and a good image cannot be observed.

Accordingly, this example sets the reflectance of the half-mirror 212 to 25%, thereby reducing the amount of external light ghost light. The conventional half-mirror has reflectance of 50%, so the efficiency in a case where external light is reflected twice is 25%. In a case where the reflectance of the half-mirror 212 is set to 25%, the efficiency in the case of two reflections is 6%, which is a decrease to about 25%. Thus, as described in Example 1, in order to reduce the external light ghost, the reflectance of the half-mirror 212 may be set to 35% or less, or 30% or less.

Table 2 summarizes the film configuration of the half-mirror 212 in this example, and FIG. 14 illustrates the reflectance characteristic of the half-mirror 212. A horizontal axis represents wavelength, and a vertical axis represents reflectance. As illustrated in Table 2, the half-mirror 212 made from a dielectric multilayer film can realize a half-mirror with reflectance lower than that of the conventional mirror. In this example, the dielectric multilayer film constituting the half-mirror 212 contains alternating layers of silicon oxide and niobium oxide.

TABLE 2

| | REFRACTIVE INDEX | FILM THICKNESS [nm] |
|---|---|---|
| SUBSTRATE | 1.54 | |
| SiO₂ | 1.46 | 86.8 |
| Nb₂O₅ | 2.15 | 23.8 |
| SiO₂ | 1.46 | 48.4 |
| Nb₂O₅ | 2.15 | 70.8 |
| SiO₂ | 1.46 | 78.1 |
| Nb₂O₅ | 2.15 | 91.0 |
| SiO₂ | 1.46 | 139.8 |

As in Example 1, in a case where the half-mirror 212 with low reflectance is used, the variation in the reflectance within the mirror surface significantly affects the display efficiency of light from the display element 208. Thus, the variation in the reflectance (and transmittance) within the mirror surface of the half-mirror 112 may be ±5% or less.

In a case where the half-mirror 212 with the reflectance of 25% is used as in this example, the reflectance×transmittance as the display efficiency is 18.75%, but in a case where the reflectance and transmittance vary by ±10%, the display efficiency becomes 12.75%, which is a decrease of 6%. Thus, this example keeps the variation in reflectance and transmittance to ±3% by reducing the variation in the thickness of the dielectric multilayer film. As a result, the reflectance×transmittance as the display efficiency becomes 17.16%, which is a suppressed decrease of about 1.6%.

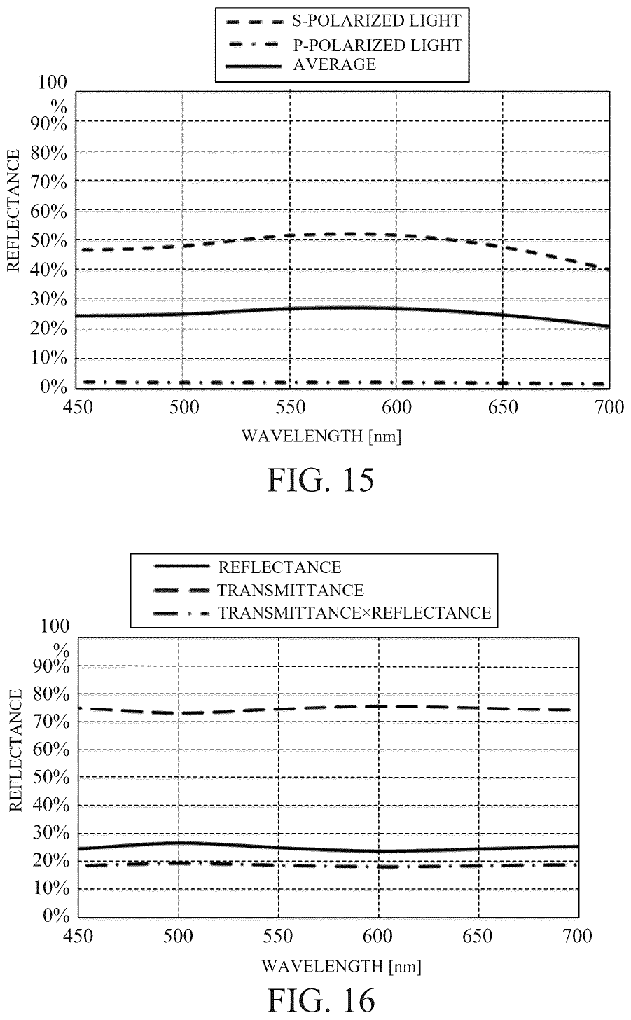

As in Example 1, in the half-mirror 212 of the dielectric multilayer film, the polarization characteristic changes according to an incident angle of the light on the half-mirror 212. FIG. 15 illustrates the reflectance characteristic of the half-mirror 212 in a case where the incident angle of the light on the half-mirror 212 is 45°. A horizontal axis represents wavelength, and a vertical axis represents reflectance. As the incident angle increases, a reflectance difference between S-polarized light and P-polarized light incident on the half-mirror 212 increases. In this case, unpolarized external light incident on the display optical system becomes linearly polarized light when it transmits through the PBS 214, and this linearly polarized light becomes circularly polarized light when the linearly polarized light transmits through the second waveplate 213. In a case where the circularly polarized external light is reflected by the half-mirror 212 that has no polarization characteristic, it is reflected as circularly polarized light, but if the half-mirror 212 has a polarization characteristic, it is reflected as elliptically polarized light. In a case where the elliptically polarized reflected external light transmits through the second waveplate 213 and enters the PBS 214, it is separated into light that transmits through the PBS 214 and exits the display optical system, and light that is reflected by the PBS 214.

As described in Example 1 with reference to FIG. 7, the light that is reflected once by the half-mirror 212 and exits the display optical system follows an optical path that is less likely to be guided to the eyeball, and is therefore less likely to become an external light ghost. In addition, an amount of light that is reflected twice by the half-mirror 212 and exits the display optical system is reduced because light occurs that is reflected once by the half-mirror 212 and exits the display optical system, and thus the external light ghost is reduced.

The reflectance difference on the half-mirror 212 between S-polarized light and P-polarized light may be 30% or more. This configuration improves the effect of reducing the external light ghost caused by the external light reflected twice by the half-mirror 112.

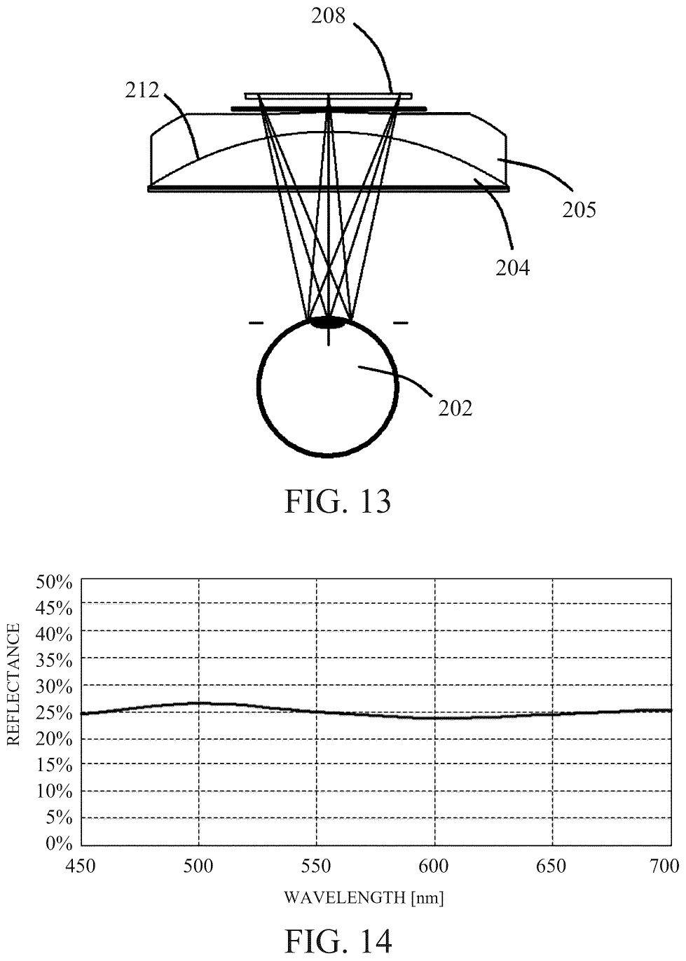

As in Example 1, in the display optical system according to this example, ghost light, which is unnecessary light that does not follow the optical path of the normal light illustrated in FIG. 11, is generated as illustrated in FIG. 13 due to the birefringence of the lenses 204 to 207 and the polarization characteristics of the first polarizing plate 210, the first and second waveplates 211 and 213, and the PBS 214.

In a case where the optical path of the normal light in FIG. 11 is compared with the optical path of the ghost light in FIG. 13, in the optical path of the normal light, the light emitted from the display element 108 transmits through and is reflected by the half-mirror 212, but in the optical path of the ghost light, the light only transmits through the half-mirror 212. Thus, in a case where the reflectance of the half-mirror 212 is low and the transmittance is high as in this example, the intensity of the internal ghost increases.

Hence, the birefringence in an area near the center of each of the lenses 204 to 207 may be small. In this example, a phase difference amount per mm of the lens thickness of the lenses (one lens) 205 and 207 on the display element side is 8 nm/mm, and a phase difference amount per mm of the lens thickness of the lenses (the other lens) 204 and 206 on the observation side is 1 nm/mm. The phase difference amount per mm of the lens thickness of each lens may be 10 nm/mm or less. In addition, since light transmits through the lenses 204 and 206 three times, the birefringence may be smaller, for example, the phase difference amount per mm of the lens thickness may be 5 nm/mm or less.

As in Example 1, any reflectance difference of the half-mirror 212 for each wavelength causes a difference between the spectral characteristic of the half-mirror 212 in the optical path of the normal light and the spectral characteristic of the half-mirror 212 in the optical path of the ghost light. As a result, the color shift between the normal light and the ghost light increases, and the ghost light is likely to stand out.

Accordingly, this example sets the reflectance and transmittance characteristics of the half-mirror 212 at an incident angle of 0° as illustrated in FIG. 16. In FIG. 16, a horizontal axis represents wavelength, and a vertical axis represents reflectance. In other words, this example reduces the difference between the spectral characteristic of the half-mirror 212 for the normal light and the spectral characteristic of the half-mirror 212 for the ghost light by reducing the reflectance difference of the half-mirror 212 for each wavelength within the visible light range. In FIG. 16, the spectral characteristic of the half-mirror 212 for the normal light is illustrated in a graph of “transmittance×reflectance,” and the spectral characteristic of the half-mirror 212 for the ghost light is illustrated in a graph of “transmittance.” Since the difference in the spectral characteristic illustrated in these graphs is small, the color shift between the normal light and the ghost light is small, and the ghost light is less likely to stand out.

For example, the dominant wavelength of the blue light emitted from the display element 208 is 470 nm, the dominant wavelength of the green light is 545 nm, and the dominant wavelength of the red light is 605 nm. The reflectances of the half-mirror 212 for the first wavelength of 470 nm, the second wavelength of 545 nm, and the third wavelength of 605 nm are 26%, 25%, and 24%, respectively. In this case, a difference between the maximum reflectance value and the minimum reflectance value at the dominant wavelengths of the blue light, green light, and red light emitted from the display element 108 is 2%. This difference may be 5% or less.

In this example, the dielectric multilayer film serving as the half-mirror 212 has a seven-layer structure. As described in Example 1, the number of layers of the dielectric multilayer film may be 5 or more and 10 or less.

In this example, the lenses 204 and 205 are cemented together. Thus, the half-mirror 212 may be vapor-deposited on the surface on the eyeball side of the lens 205. Even in this case, the surface on which the half-mirror 212 is vapor-deposited is a surface that is convex toward the display element side. Forming the lenses 204 and 205 as cemented lenses enables these lenses to be easily held.

In a case where the lenses 204 and 205 are cemented together, by arranging the cemented surfaces of the lenses 204 and 205 so that they are convex downward (concave upward) as illustrated in FIG. 17, adhesive can be easily applied to the cemented surfaces. Generally, an ultraviolet curable resin is used as the adhesive. In this case, in a case where ultraviolet light (with a wavelength, for example, of less than 400 nm) 215 is irradiated from above as illustrated in FIG. 17, the ultraviolet light 215 is reflected by the half-mirror 212, and is internally reflected by the top surface (flat surface) of the lens 204, and is condensed on the adhesive between the lenses 204 and 205. Since the intensity of the ultraviolet light 215 is higher at a portion of the adhesive where the ultraviolet light 215 is condensed, the ultraviolet curable resin cures there faster than at a portion where the ultraviolet light 215 is not condensed. As a result, unnecessary stress is generated in the adhesive due to a difference in curing speed between the portion where the ultraviolet light 215 is condensed and the portion where the ultraviolet light 215 is not condensed. Therefore, in order to reduce the generation of unnecessary stress, the reflectance of the half-mirror 212 in the ultraviolet range may be low.

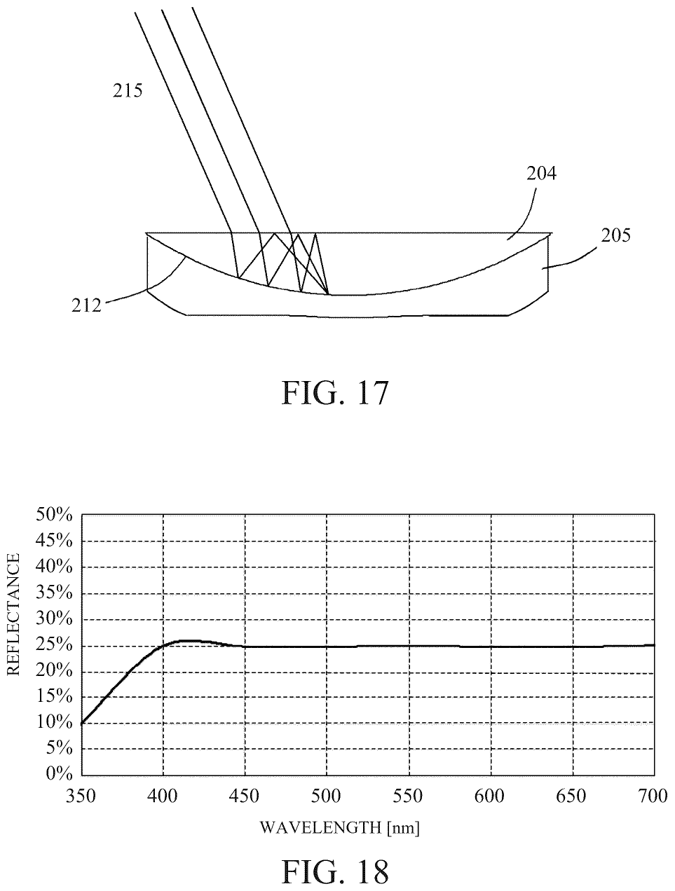

FIG. 18 illustrates the reflectance characteristic of the half-mirror 212 in a case where the film configuration of the dielectric multilayer film for the half-mirror 212 is summarized in Table 3. In FIG. 18, a horizontal axis represents wavelength, and a vertical axis represents reflectance.

TABLE 3

| | REFRACTIVE INDEX | FILM THICKNESS [nm] |
|---|---|---|
| SUBSTRATE | 1.54 | |
| SiO2 | 1.46 | 155.4 |
| Nb₂O₅ | 2.15 | 23.5 |
| SiO₂ | 1.46 | 9.4 |
| Nb₂O₅ | 2.15 | 65.3 |
| SiO₂ | 1.46 | 102.7 |
| Nb₂O₅ | 2.15 | 68.1 |
| SiO₂ | 1.46 | 60.0 |
| Nb₂O₅ | 2.15 | 23.8 |
| SiO₂ | 1.46 | 64.1 |

As illustrated in FIG. 18, the number of layers in the dielectric multilayer film is nine, and the reflectance at 350 nm in the ultraviolet range is as low as 10%. Setting the reflectance of the half-mirror 212 lower in the ultraviolet range than in the visible light range in this manner can reduce unnecessary stress on the cemented surfaces of the lenses 204 and 205.

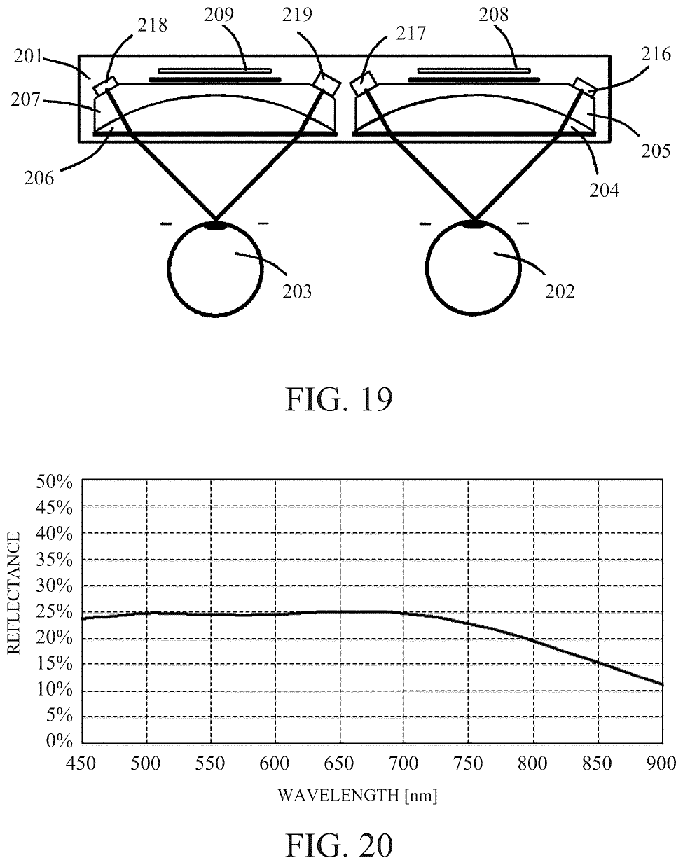

As illustrated in FIG. 19, the HMD 201 may include infrared light sources 216 and 218 and infrared cameras 217 and 219 as detectors configured to detect the line of sight (visual line) of each of the right eye 202 and the left eye 203 of the observer, respectively. Infrared light (with a wavelength, for example, of 700 nm or more) emitted from the infrared light source 216 transmits through the lenses 205 and 204 and is irradiated onto the right eye 202, and the infrared light reflected by the right eye 202 transmits through the lenses 204 and 205 and is captured by the infrared camera 217. The infrared light emitted from the infrared light source 218 transmits through the lenses 207 and 206 and is irradiated onto the left eye 203, and the infrared light reflected by the left eye 203 transmits through the lenses 206 and 207 and is captured by the infrared camera 219.

Since the infrared light from the infrared light sources 216 and 218 each transmits through the half-mirror 212 twice, the reflectance of the half-mirror 212 in the infrared range may be lower than its reflectance of the half-mirror 212 in the visible range. In a case where the reflectance of the half-mirror 212 in the infrared range is low, the infrared light from the infrared light sources 216 and 218 can be irradiated onto the right eye 202 and the left eye 203 with high efficiency, and bright reflected light can be captured.

For example, the film configuration of the dielectric multilayer film as the half-mirror 212 may be as summarized in Table 4. FIG. 20 illustrates the reflectance characteristic of the half-mirror 212 in this case. A horizontal axis represents wavelength, and a vertical axis represents reflectance.

TABLE 4

| | REFRACTIVE INDEX | FILM THICKNESS [nm] |
|---|---|---|
| SUBSTRATE | 1.54 | |
| SiO₂ | 1.46 | 124.9 |
| Nb₂O₅ | 2.15 | 21.1 |
| SiO₂ | 1.46 | 4.8 |
| Nb₂O₅ | 2.15 | 58.4 |
| SiO₂ | 1.46 | 74.8 |
| Nb₂O₅ | 2.15 | 55.5 |
| SiO₂ | 1.46 | 54.1 |
| Nb₂O₅ | 2.15 | 13.4 |
| SiO₂ | 1.46 | 106.5 |

As illustrated in FIG. 20, the number of layers of the dielectric multilayer film is nine, and thus the reflectance at 900 nm in the infrared range is as low as 10%.

In this example, a second polarizing plate may be disposed between the PBS 214 and the eyeball to reduce external light ghost and increase the contrast of the displayed image.

In this example, the surface on the eyeball side of the lens 204 on which the second waveplate 213 and the PBS 214 are provided, is flat. In other words, the lens 204 is a plano-convex lens. This configuration can increase the eye relief and reduce the thickness of the display optical system.

In this example, the phase difference of each of the first and second waveplates 211 and 213 may be shifted from λ/4 so as to cancel the birefringence of the lenses 204 and 205. The sum of the phase differences of the lens 204 and the phase difference plate 213 may be 3λ/20 or more and 7λ/20 or less. The sum of the phase differences of lens 205 and retardation plate 211 may be 3λ/20 or more and 7λ/20 or less.

In this example, the display element uses an organic EL element configured to emit unpolarized light, but may use a liquid crystal element configured to emit linearly polarized light so as to omit the first polarizing plate 210 and further reduce the thickness of the display optical system.

While the disclosure has described example embodiments, it is to be understood that the disclosure is not limited to the example embodiments. The scope of the following claims is to be accorded the broadest interpretation so as to encompass all such modifications and equivalent structures and functions.

Each example can reduce an external light ghost in a display optical system that utilizes polarization.

This application claims priority to Japanese Patent Application No. 2024-043099, which was filed on Mar. 19, 2024, the entire disclosure of which is hereby incorporated by reference herein.

What is claimed is:

1. A display optical system configured to guide light, the display optical system comprising:
a partially transmissive reflective surface including a dielectric multilayer film including five layers or more and ten layers or less; and
a polarizing splitting surface,
wherein the partially transmissive reflective surface has a reflectance of 35% or less for visible light.

2. The display optical system according to claim 1, wherein the reflectance of the partially transmissive reflective surface is 20% or more.

3. The display optical system according to claim 1, wherein the display optical system is configured to guide light from a display element to an observation side via transmission through the partially transmissive reflective surface, wherein the light reflects on the polarizing splitting surface, reflects on the partially transmissive reflective surface, and is transmitted through the polarizing splitting surface.

4. The display optical system according to claim 1, wherein the partially transmissive reflective surface has a convex shape toward a display element and an aspheric shape.

5. The display optical system according to claim 1, wherein variation in the reflectance within a surface of the partially transmissive reflective surface is approximately five percent or less.

6. The display optical system according to claim 1, further comprising a resin lens,
wherein a phase difference amount per mm of thickness of the resin lens is 10 nm/mm or less.

7. The display optical system according to claim 1, further comprising a first resin lens and a second resin lens,
wherein a phase difference amount per mm of thickness of the first resin lens is 10 nm/mm or less, and
wherein a phase difference amount per mm of thickness of the second resin lens, disposed on an observation side of the first resin lens, is 5 nm/mm or less.

8. The display optical system according to claim 1, wherein, at an incident angle where external light from an observation side transmits through the polarizing splitting surface and enters the partially transmissive reflective surface, a difference in the reflectance of the partially transmissive reflective surface for each of first linearly polarized light and second linearly polarized light that have polarization directions orthogonal to each other is 20% or more.

9. The display optical system according to claim 1, wherein a difference between a maximum value and a minimum value of the reflectance of the partially transmissive reflective surface for each of light of a first wavelength, light of a second wavelength, and light of a third wavelength is 15% or less, and
wherein the first wavelength, the second wavelength, and the third wavelength are different from one another, and each of the light of the first wavelength, the light of the second wavelength, and the light of the third wavelength is visible light.

10. The display optical system according to claim 9, wherein the light from the display element includes three colors of light having dominant wavelengths at the first wavelength, the second wavelength, and the third wavelength, respectively.

11. The display optical system according to claim 1, further comprising two lenses cemented together via an ultraviolet curable resin,
wherein the partially transmissive reflective surface is disposed at a cemented portion between the two lenses, and
wherein the reflectance of the partially transmissive reflective surface for ultraviolet light is lower than the reflectance of the partially transmissive reflective surface for the visible light.

12. The display optical system according to claim 1, wherein the display optical system is used with a detector configured to detect a line of sight of an eyeball disposed on an observation side by irradiating the eyeball with infrared light and capturing reflected infrared light,
wherein the infrared light transmits through the partially transmissive reflective surface, and
wherein the reflectance of the partially transmissive reflective surface for the infrared light is lower than the reflectance of the partially transmissive reflective surface for the visible light.

13. The display optical system according to claim 1, wherein light from a display element from which the display optical system guides light is unpolarized light, and
wherein a polarizing plate and a waveplate are disposed in this order between the display element and the partially transmissive reflective surface.

14. An image display apparatus comprising:
a display element; and
a display optical system configured to guide light from the display element to an observation side,
wherein the display optical system includes:
a partially transmissive reflective surface having a reflectance of 35% or less for visible light, and including a dielectric multilayer film of five to ten layers; and
a polarizing splitting surface.
